(19) United States
(12) Patent Application Publication
(10) Pub. No.: US 2025/0073514 A1
(43) Pub. Date: Mar. 6, 2025

(54) House Fire Fighting Technique

(71) Applicants: Peter Aung Hla, Washington, DC (US); Myint Myint San, Washington, DC (US)

(72) Inventors: Peter Aung Hla, Washington, DC (US); Myint Myint San, Washington, DC (US)

(21) Appl. No.: 18/915,169

(22) Filed: Oct. 14, 2024

(51) Int. Cl. A62C 99/00

(52) U.S. Cl. CPC A62C 99/0045; A62C 99/0027; A62C 99/009

(57) ABSTRACT

This patent is about fighting House/Apartment/Condo/Building fires by using Dry Ice and/or Carbon Dioxide Gas. By the time people call the authorities, the fire has grown so big that it is difficult to control or to extinguish by ordinary fire fighting techniques. Traditional house fire fighting is to spray water into the house so that the flames would disappear and stop burning. This patent involves two methods: 1) throwing, spraying or spreading powder or flakes or pellets of Dry Ice on or near the fire or around the fire so that the Carbon Dioxide sublimating from it diffuses and expands to get to the fire or to fill up the house or around the house so that Oxygen cannot get into the fire to continue burning; 2) spraying Carbon Dioxide gas into the house, apartment or building to bring down the Oxygen level to stop the fire.

### TECHNICAL FIELD

The present disclosure relates to extinguishing house fires using Carbon Dioxide and Dry Ice.

### BACKGROUND

Shelby Hall wrote in “Fire Loss in the United States”, “In 2022, local fire departments responded to an estimated 1.5 million fires in the United States. These fires caused 3,790 civilian fire deaths and 13,250 reported civilian fire injuries. The property damage caused by these fires was estimated at $18 billion. On average, a fire department responded to a fire somewhere in the US every 21 seconds in 2022. A home structure fire was reported every 88 seconds, a home fire death occurred every three hours and fourteen minutes, and a home fire injury occurred every 53 minutes.”

U.S. Fire Administration reported that as of September 2024, 40 Firefighters and 1,403 civilians died because of fires.

Currently, spraying water on building fires by firefighters is the normal way of fighting house/building fires. By watching on Youtube at the videos of firefighters spraying water on house fires, it does not seem very effective. It is not easy as fires may be burning in an area unreachable directly by the water. Firefighters could be seen to direct the water into the windows or the roof. The fires kept burning because the water stream was unable to reach the fire behind the wall or inside the ceiling under the roof. Fires continued to burn for quite some time. Any valuable things in the house would also be damaged by water. Thus, it is apparent that we need a new and effective house fire firefighting technique.

### SUMMARY

### Using Dry Ice

Once firefighters arrive at a house fire, packages of Dry Ice powder/small pellets/flakes should be thrown into the house from any available doors and windows. The packages or buckets of Dry Ice should be packed in a way to allow the Dry Ice to spread out as much as possible after being thrown. Dry Ice should be placed on a plastic sheet and the edges should be picked up or collected and hold tight together without tying up with strings. When this pack of Dry Ice is thrown into the window or door, it will release all the Dry Ice which will spread out onto the floor. The more it spreads, the more quickly it sublimates. If the fire is burning upstairs, Dry Ice can even be thrown into the doors or windows downstairs because the Carbon Dioxide from it can be sucked up to the fires.

Drones carrying powder of Dry Ice should be flown into the house to dump packages of pellets of Dry Ice or spray or spread the powder of Dry Ice in as many rooms as possible. After emptying the powder of Dry Ice, the drones can come out to refill and repeat the process again.

Powder of Dry Ice can also be spread outside of the building especially, over the windward side of the fire if fire is burning outside of the building. With other large fires, dry ice has to be spread on the fire and on all sides of the fire to cut off the Oxygen from the surrounding area. The air around the fire is 78% Nitrogen, 21% Oxygen, 0.9% Argon and 0.04% Carbon Dioxide. With plenty of Oxygen, the fire will burn brighter and as the Carbon Dioxide produced by the burning is hot, it rises and creates low pressure at the base of the fire which sucks in more Oxygen to burn.

Oxygen content needs to be more than 15% in the air for diffusion flame production and when the Carbon Dioxide from the dry ice expands and rushes into the fire, it stops burning as there is more Carbon Dioxide around the fire. Kate S. Zalzal wrote for the Earth Magazine saying, “They have found that fires, even if ignited, will not propagate if the atmospheric oxygen concentration is below 16 percent. At our modern oxygen level of 20.9 percent, fires ignite and propagate readily.”

When cold Carbon Dioxide from dry ice overwhelms the inside of the house and the surrounding area, Oxygen cannot get near the fire and the fire will die down.

Powder of Dry Ice will be sprayed or spread out over the fire or close to the fire. The powder or flake of dry ice is small enough to sublimate quickly after hitting the floor. The drone that sprays Dry Ice can be flown closer to the fire and can spray Dry Ice directly into the fire for it to quickly sublimate because of the heat.

Dry Ice is frozen Carbon Dioxide. It sublimates (evaporates directly into gas) at −78.5 degrees Celsius or −109.2 degrees Fahrenheit. Before the carbon dioxide gas gets to the Standard Temperature (0 degree Celsius), it absorbs the heat from the scene of the fire and as it gets hotter, it expands. This cools the temperature of the scene of the fire.

Carbon Dioxide molecule has one Carbon atom (atomic weight 12) and two Oxygen atoms (each has atomic weight 16). As Carbon Dioxide has a molecular weight of 44 (12+16+16), there is 44 gm in one mole. One mole of gas at Standard Temperature and Pressure (0 degree Celcius and 1 ATM) is 22.4 Liters. So one pound (454 gm) of dry ice will produce about 231 liters (61 gallons) of Carbon Dioxide gas at STP. The temperature at the fire scene can be hundreds of degrees. Let's assume it is about 200 degrees Celsius (It could be up to more than 1000 degrees Celsius). According to Boyle's and Charles' law P₁ V₁/T₁=P₂ V₂/T₂, The volume of Carbon Dioxide from the one pound of the dry ice without considering the air pressure would be more than 400 liters or more than 105 gallons. If 10 lbs of dry ice are dropped in the house, the volume of Carbon Dioxide would be more than 1,000 gallons. When this Carbon Dioxide pushes into the fires, Oxygen does not have a chance to get in and combine with the fuel. House fire will be extinguished.

University of Massachusetts Amherst says in its Environmental Health & Safety page under the heading “What are the hazards”, “Cryogens and dry ice can expand 700 to 900 times their volume upon boiling/sublimation.” Department of Biology at the University of York says on its website that 10 kg of dry ice sublimes into about 5.4 cubic meters of carbon dioxide gas. (That means 22 lbs of Dry Ice sublimes into 1426 gallons and if this expands 800 times, it would be about 1,140,000 gallons.) And the expansion ratio of dry ice is 845. That means 1 lb of dry ice would sublime into 6.5 gallons of carbon dioxide. So if this gas is heated from −78 degrees Celsius to 200 degrees, the volume would be more than 158 gallons. 100 lbs of dry ice would produce more than 15,800 gallons of Carbon Dioxide gas occupying the whole house. However, it should be noted that not all the Dry Ice would sublimate immediately into gas once it gets in the burning house.

Fire engine trucks hold from about 300 to 1,250 gallons of water with an average of 500 gallons. Water sprayed on fires does not expand like Dry Ice and extinguish fires only on contact even though the steam coming out of the fire does suppress the fire. Most of the water just flows down the floors and to the ground. Properties in the house are also damaged by the water. However, Carbon Dioxide is gas and will not damage properties in the house.

A fire that is burning has only three elements: Fuel (wood or furniture), flames and Oxygen from the air. Fuel and Oxygen combine with the help of the heat from the flames and produce hot Carbon Dioxide and other toxic fumes and soot which rise up into the sky because hot air is lighter. Oxygen from the cold surrounding air rushes in towards the flames because the pressure at the base of the fire is low and so the burning goes on. When the Carbon Dioxide from the dry ice expands and comes up from the floors, it pushes out the Oxygen from the surrounding air that is rushing in to the flames. The flames cannot get enough Oxygen to continue burning and the fire is snuffed out. This Carbon Dioxide from Dry Ice, unlike the hot Carbon Dioxide that comes out of the burning flames, is quite cold and so it does not rise up but rushes in to the fires because the low pressure surrounding the burning flames suck in the cold Carbon Dioxide instead of Oxygen. In turn, the fire stops burning because it cannot get enough of the Oxygen it needs.

The volume of Carbon Dioxide from the dry ice is several times greater than the water or fire retardants and also it can extinguish fires that the dry ice does not touch because the cold Carbon Dioxide can rush towards adjacent fires or fires behind the wall or in another room. So using dry ice to extinguish fires is much better.

The cost of dry ice is about $1.00 per lb. Carbon Dioxide to produce Dry Ice is reclaimed from industries and so it is not only cheap but also does not harm the environment. In addition to Dry Ice, Carbon Dioxide gas from cylinders can also be used to fight house fires.

### Using Carbon Dioxide Gas

Firefighters can carry a 10 lb, 20 lb or 50 lb Carbon Dioxide cylinders on their backs or by hand and can spray the gas into any opening of the house or building or a Condo apartment. Drones carrying Carbon Dioxide cylinders can be sent out to spray the gas into the windows or doors or into the house or room where the fire is burning. They don't have to even enter the building. If the fire is too big, each fire fighter could even use two cylinders at the same time to spray Carbon Dioxide gas into an opening. The gas will expand and reduce the ratio of available Oxygen to below 16% so that fire can stop burning. Carbon Dioxide just needs to dilute Oxygen to below 16% to snuff out the fire. Fire fighters should be careful because Carbon Dioxide spray coming out of the cylinders can be very cold and could hurt eyes and skins.

It should be noted that Carbon Dioxide is heavier than air and will flow to lower levels and if there are people in the house, people inside the room or basement or lower floors will not be able to get enough Oxygen to breathe. After the fire is extinguished, big fans or leaf blowers can be turned on to push the Carbon Dioxide out until it is safe for people to enter the house of the building or the apartment.

Fire trucks can also carry bigger Carbon Dioxide cylinders and plastic pipes and (garden hoses) reels. Instead of unrolling water truck hose and joining them, just unrolling the long plastic pipe will save time. Firefighters can then aim the Carbon Dioxide gas into the doors or windows or openings of the house or building to extinguish the fire. The spraying end of the hose can even be carried by drones to higher rooms.

Not every local Fire and EMS station in a city needs to store Dry Ice or Carbon Dioxide cylinders. Only a few of the stations need to store them and bring to the house fire when necessary.

There are important things to note when using Dry Ice and Carbon Dioxide as firefighting agent. Firefighters handling Dry Ice should be trained in the handling and dangers of it. It cannot be in totally closed box. It must not be handled with bare hands. It cannot be transported in a car with windows closed. People handling Dry Ice need to wear Safety glasses. If there are people in the building, firefighters should consider whether it is prudent to use Dry Ice. Both the fire with toxic fumes and the Carbon Dioxide from the Dry Ice can kill a living person. Firefighters going into the house after the fire dies down must be careful. Carbon Dioxide from the fire and from the Dry Ice or the Carbon Dioxide cylinder will linger in the house and any person or animal may die from lack of Oxygen. So as soon as it is safe to go into the house, it should be immediately checked to see whether someone is inside. If so, they should be immediately treated and bring out to fresh air.

A website “co2meter dot com” says, “CO₂ cylinder pressure is about 860 psi at normal room temperature. Typical CO₂ cylinders store about 20 lbs or 50 lbs. of liquid CO2. Two pounds of liquid CO₂ expands to about 20 cubic feet of gaseous CO₂ at atmospheric pressure, or expands at a rate of 535:1. This means that in an enclosed room the CO₂ gas can quickly fill with CO₂ and either poison an individual or displace all the oxygen available for breathing. Because CO₂ is heavier than air it will also fill any low areas like basements or under floor service areas first. If there is little air movement, pools of CO₂ can exist for many hours. Liquid CO₂ temperature is also important. If the gas escapes quickly, it is discharged at sub zero temperatures and produces a mixture of CO₂ gas and “snow”. This “CO₂ snow” is momentarily the same temperature as dry ice (about −110 F. or −79 C.) and can quickly result in frostbite or frozen skin.” However, most of the Carbon Dioxide would be suck up by the low pressure of the fire.

When fighting metal fires, one should be careful about the use of Dry Ice. “Note that certain metals react exothermically with nitrogen or carbon dioxide, so the only acceptable inert gases for these metals are helium and argon. Halons should not be used on metal fires.” (PDHonline Course M282: Fire Dynamics Series: Fire Protection Fundamentals. Instructor: Lawrence J. Marchetti. p-31).

One should also know that according to Hazmat University, Dry Ice is regulated in transportation and shipping is limited to 200 Kg (441 lbs). Whoever handling Carbon Dioxide cylinders should also be familiar with 46 CFR § 147.65—Carbon dioxide and Halon fire extinguishing systems.

### BRIEF DESCRIPTION OF DRAWINGS

FIG. 1: Plastic Container to carry packages of Dry Ice to the house fire.

FIG. 2: Plastic Container to carry packages of Dry Ice to the house fire.

FIG. 3: Plastic sheet (with very small holes) to pack Dry Ice to be thrown into the burning building.

FIG. 4: Dry Ice in plastic sheet. The circular edge is collected and gripped together without tying with a string.

FIG. 5: Drone 1 carrying Dry Ice to be spread out in the burning building.

FIG. 6: Drone 2 carrying Dry Ice to be spread out in the burning building.

FIG. 7: Drone 3 carrying Dry Ice to be sprayed in the burning building.

FIG. 8: Drone 4 carrying Dry Ice to be sprayed in the burning building.

FIG. 9: Drone 5 carrying Carbon Dioxide cylinder

FIG. 10: Using Dry Ice and Carbon Dioxide Gas and drones to fight a fire with Firefighters.

FIG. 11: Drone 6 to dump Dry Ice in the burning building.

### REFERENCE NUMBERS (SPECIFICATION)

1. Drone with a width of less than the width of most doors and windows.
2. Container for Dry Ice. It must not be totally closed.
3. Controllable opening to two Dry Ice dropping pipes.
4. Dry Ice spreader fan.
5. Payload Release Mechanism.
6. Hook attached to a string that can get detached from Payload Release Mechanism.
7. Dry Ice pack hanging by the string tied between Payload Release Mechanism and the hook.
8. String tying the Dry Ice pack to Payload Release Mechanism and the hook.
9. Drone with a width of less than the width of most doors and windows.
10. Dry Ice dropping Container (It must not be totally closed).
11. Pipe to drop Dry Ice into the spray pipe.
12. Air pump
13. Payload Release Mechanism
14. Hook attached to a string that can get detached from Payload Release Mechanism.
15. Dry Ice pack hanging by the string tied between Payload Release Mechanism and the hook.
16. String tying the Dry Ice pack to Payload Release Mechanism and the hook.
17. Dry Ice spraying pipe.
18. Drone to carry Carbon Dioxide cylinder
19. Remote controlled turn on valve
20. Pipe to spray Carbon Dioxide
21. Carbon Dioxide cylinder
22. Drones carrying Dry Ice or Carbon Dioxide.
23. Carbon Dioxide spray coming out of the pipes.
24. Long straight pole to support the pipe that is carrying Carbon Dioxide liquid.
25. Pipes carrying Carbon Dioxide liquid from the Carbon Dioxide cylinder.
26. Cylinders of Carbon Dioxide.
27. Fire fighters
28. Drone to dump Dry Ice
29. Hole to release Carbon Dioxide gas
30. Container to carry Dry Ice
31. Dry Ice
32. Hinge of the bottom door to release Dry Ice
33. One side of the Bottom door
34. Door lock controlled remotely

### DESCRIPTION

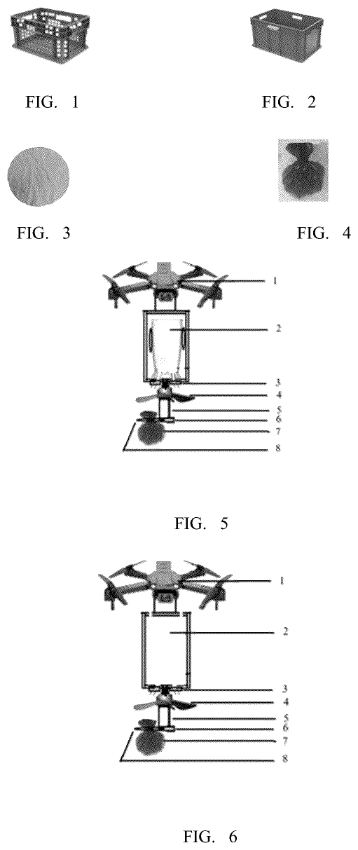

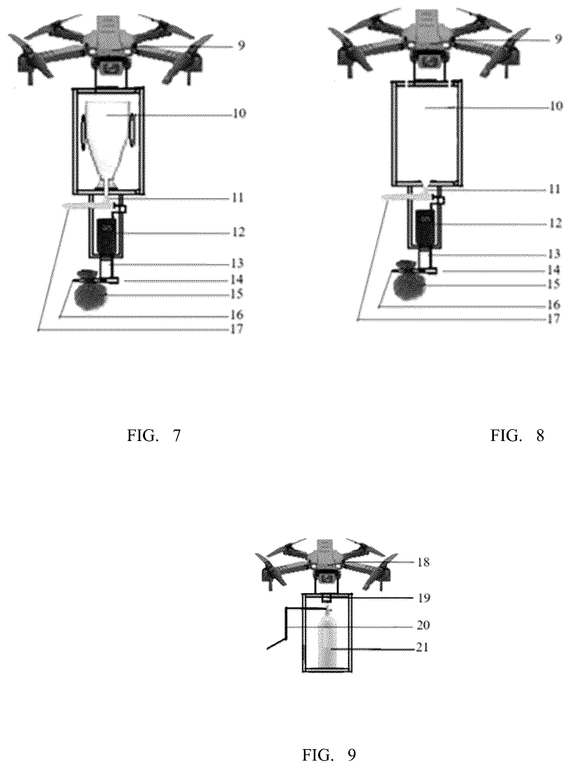

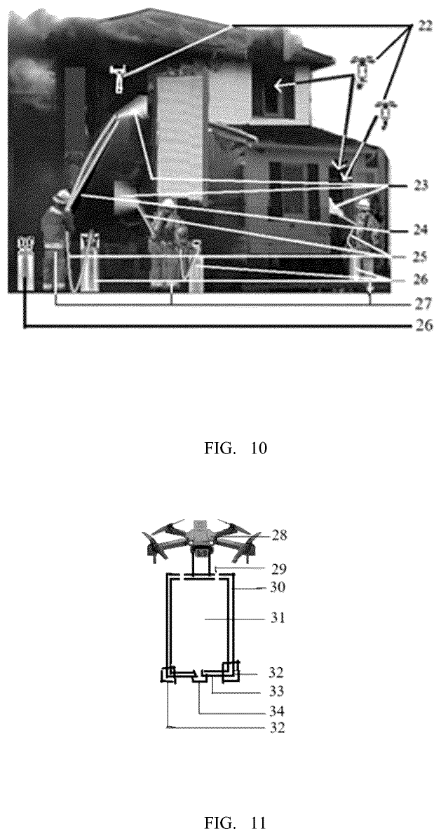

1. Dry Ice and Carbon Dioxide cylinders can be carried in bulk to where the fire is burning.
2. If it is possible to throw the Dry Ice into the building by the firefighters, powder of Dry Ice can be put on the plastic sheet (FIG. 3) and the circular edge must be collected into bunch and the Dry Ice packs (FIG. 4) are carried in plastic containers (For example: FIG. 1 and FIG. 2). Dry Ice packs must not be tied up. The packs can be thrown by the firefighters into or around the building. Since the plastic sheets are not tied by strings, once it hit the floor, Dry Ice will spread out which enables it to sublimate more easily.
3. If firefighters decide that it is better to have the drones carry the Dry Ice packs into the building, there are six kinds of drones to do that. (FIG. 5, 6, 7, 8, 9 and FIG. 11.) Since the drones have cameras, the operators can direct them as close as possible to the fire before dropping/spreading/spraying/dumping the Dry Ice remotely. Drones should have holes to let Carbon Dioxide gas escapes.
4. Payload Release Mechanism can be controlled remotely to drop Dry Ice pack.
5. First drone in FIGS. 5 and 6 has two openings for Dry Ice to drop. Both openings are controlled to open or close separately. The fan underneath is to spread the Dry Ice that drops onto it. The fan will spread the Dry Ice that drops from one opening to one side and from the other opening to the other side. By closing one side, the other side will spread Dry Ice to only one side of the drone.
6. Second drone in FIGS. 7 and 8 has only one opening in the bottom for Dry Ice to drop into the pipe to spray it. The air pump will push it out to spray it towards the fire.
7. Third drone in FIG. 11 is to carry Dry Ice and dump as much as one wants by controlling the door.
8. If needed, the drones can be controlled to come out and refill again.
9. There are three ways to spray Carbon Dioxide into a building that is burning: from one or two cylinders that a firefighter is carrying (FIG. 10), or from drones carrying Carbon Dioxide cylinders (FIG. 9), or by using a plastic pipe directly coming from a fire truck carrying a bigger Carbon Dioxide cylinder. If fire is too big, one firefighter can hold two spray pipes coming out of two cylinders at the same time.
10. If the fire is in a room several floors up, the spray pipe can be carried by a drone to spray into the opening. If firefighter has oxygen tank, he can go inside to spray.
11. After the fire is extinguished. fans or leaf-blowers are used to blow off the remaining Carbon Dioxide in the house or building for people to safely enter it.

What is claimed:

1. The use of powder or pellets or flakes of Dry Ice to control or extinguish house, apartment, condo and building or other fires by throwing, spreading, dumping or spraying them into or around or on the fire scene or in, on or over or around the house or building.

2. The use and constructing or manufacturing of Drones as shown in FIGS. 5 and 6 (drones to spread Dry Ice), FIGS. 7 and 8 (drones to spray Dry Ice), FIG. 9 (drones to spray Carbon Dioxide gas) and FIG. 11 (drones to dump Dry Ice) and any similar drones that can carry Dry Ice and Carbon Dioxide gas to be spread or sprayed remotely.

3. The use of Carbon Dioxide Gas from cylinders carried by firefighters (people) or by drones, or by fire trucks to spray into, on or around a burning building/house/apartment to extinguish the fire.

4. When Carbon Dioxide gas is sprayed into a building as in claim 3, if the pipe carrying the Carbon Dioxide gas needs to be longer, it should be supported by a long rigid pole or the spray end of the pipe to spray Carbon Dioxide gas should be carried by a drone to higher places.

5. The use of fans or leaf-blowers to blow off the excess Carbon Dioxide through windows, doors or openings after the fire is extinguished as in claim 3.
